(19) United States
(12) Patent Application Publication
(10) Pub. No.: US 2025/0355166 A1
(43) Pub. Date: Nov. 20, 2025

(54) OPTICAL CIRCUIT BOARD AND OPTICAL COMPONENT MOUNTING STRUCTURE

(71) Applicant: KYOCERA Corporation, Kyoto-shi, Kyoto (JP)

(72) Inventor: Akifumi SAGARA, Kyoto-shi (JP)

(73) Assignee: KYOCERA Corporation, Kyoto-shi, Kyoto (JP)

(21) Appl. No.: 18/861,110

(22) PCT Filed: Apr. 26, 2023
(86) PCT No.: PCT/JP2023/016393

§ 371 Date: Oct. 28, 2024

(30) Foreign Application Priority Data
Apr. 28, 2022 (JP) 2022-074085

(51) Int. Cl. G02B 6/12

(52) U.S. Cl. CPC G02B 6/12004

(57) ABSTRACT

An optical circuit board includes a wiring board and first and second optical waveguides positioned on the wiring board. The first optical waveguide includes a first lower clad, a first core, and a first upper clad covering at least part of the first core. The second optical waveguide-includes a second lower clad, a second core, and a second upper clad covering at least part of the second core. The second optical waveguide includes a first end surface at which a first core end surface of the second core is exposed on an outer edge side of the wiring board and includes a second end surface at which a second core end surface of the second core is exposed on a center side of the wiring board. At the first end surface and/or the second end surface, a gap is between the second core and the second upper clad.

### TECHNICAL FIELD

The present invention relates to an optical circuit board and an optical component mounting structure using the same.

### BACKGROUND OF INVENTION

An optical fiber that can transmit large amounts of data at high speed has recently been used for information communication. Optical signals are transmitted and received between the optical fiber and an optical component. Such an optical component is mounted on, for example, an optical circuit board. The optical circuit board is provided with an optical waveguide. The optical signals are transmitted and received via the optical waveguide. As described in, for example, Patent Document 1, an optical circuit board to be used for transmission and reception of the optical signals needs to be inspected whether the optical signals are normally transmitted and received.

### CITATION LIST

### Patent Literature

Patent Document 1: JP 2015-215469 A

### SUMMARY

### Solution to Problem

In the present disclosure, an optical circuit board includes a wiring board, a first optical waveguide positioned on the wiring board, and a second optical waveguide positioned adjacent to the first optical waveguide on the wiring board. The first optical waveguide includes a first lower clad positioned on the wiring board, a first core extending from an outer edge side of the wiring board to a center side of the wiring board on the first lower clad, and a first upper clad covering at least part of the first core. The second optical waveguide includes a second lower clad positioned on the wiring board, a second core positioned along the first core on the second lower clad, and a second upper clad covering at least part of the second core. The second optical waveguide includes a first end surface at which a first core end surface of the second core is exposed on the outer edge side of the wiring board and includes a second end surface at which a second core end surface of the second core is exposed on the center side of the wiring board. At the first end surface and/or the second end surface, a gap is between the second core and the second upper clad.

In the present disclosure, an optical component mounting structure includes the optical circuit board described above and an optical component mounted on the optical circuit board.

### BRIEF DESCRIPTION OF THE DRAWINGS

FIG. 1 is a plan view illustrating an optical component mounting structure in which an optical component and an electronic component are mounted on an optical circuit board according to an embodiment of the present disclosure.

FIG. 2 is an enlarged explanatory view for explaining a cross section of a region R1 illustrated in FIG. 1.

FIG. 3 is a plan view as viewed from a direction of an arrow A illustrated in FIG. 2.

FIG. 4 is an explanatory view for explaining a cross section taken along line X-X illustrated in FIG. 3.

FIG. 5 is an explanatory view for explaining a process of forming a first optical waveguide and a second optical waveguide in the optical circuit board according to the embodiment of the present disclosure.

### DESCRIPTION OF EMBODIMENTS

In an optical continuity inspection, a thin light beam (for example, having a diameter of about 9 μm) needs to be made incident on each core included in an optical waveguide. However, in an optical circuit board in a related art, visually recognizing a core at an end surface of an optical waveguide is difficult, and thus positioning for making a light beam incident is also difficult. Thus, there is a demand for an optical circuit board in which a light incident position can be easily determined at the time of inspection and which is excellent in inspection efficiency of an optical waveguide.

In the present disclosure, an optical circuit board has a configuration described in SOLUTION TO PROBLEM, and thus a light incident position can be easily determined at the time of inspection, and the inspection of an optical waveguide can be efficiently performed.

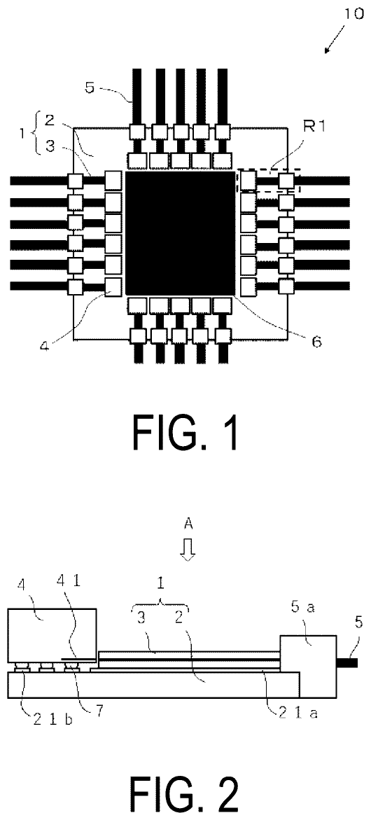

An optical circuit board according to an embodiment of the present disclosure will be described based on FIGS. 1 to 4. FIG. 1 is a plan view illustrating an optical component mounting structure 10 in which an optical component 4 is mounted on an optical circuit board 1 according to the embodiment of the present disclosure.

In the embodiment of the present disclosure, the optical circuit board 1 includes a wiring board 2 and an optical waveguide 3. Examples of the wiring board 2 included in the optical circuit board 1 according to the embodiment include a wiring board typically used for an optical circuit board.

Although not specifically illustrated, the wiring board 2 includes, for example, a core substrate and a build-up layer layered on both surfaces of the core substrate. The core substrate is not particularly limited as long as the core substrate is made of a material having an insulation property. Examples of the material having an insulation property include resin such as epoxy resin, bismaleimide-triazine resin, polyimide resin, or polyphenylene ether resin. Two or more types of the resin may be mixed and used. The core substrate usually includes a through hole conductor for electrically connecting the upper and lower surfaces of the core substrate.

The core substrate may contain a reinforcing material. Examples of the reinforcing material include insulation fabric materials such as glass fiber, glass non-woven fabric, aramid non-woven fabric, aramid fiber, and polyester fiber. Two or more types of reinforcing materials may be used in combination. An inorganic filler made of, for example, silica, barium sulfate, talc, clay, glass, calcium carbonate, or titanium oxide may be dispersed in the core substrate.

The build-up layer has a structure in which insulation layers and electrical conductor layers are alternately layered. Part of the outermost electrical conductor layer (electrical conductor layer positioned on the upper surface of the wiring board 2) includes an electrical conductor layer 21a in which the optical waveguide 3 is positioned. The electrical conductor layer 21a is made of a metal such as copper. Similar to the core substrate, the insulation layer included in the build-up layer is not particularly limited as long as the insulation layer is made of a material having an insulation property. Examples of the material having an insulation property include resin such as epoxy resin, bismaleimide-triazine resin, polyimide resin, or polyphenylene ether resin. Two or more types of the resin may be mixed and used.

When two or more insulation layers are present in the build-up layer, each of the insulation layers may be made of the same resin or may be made of different resin. The insulation layer included in the build-up layer and the core substrate may be made of the same resin or may be made of different resin. The build-up layer usually includes a via hole conductor for electrically connecting the layers.

An inorganic filler made of, for example, silica, barium sulfate, talc, clay, glass, calcium carbonate, or titanium oxide may be dispersed in the insulation layer included in the build-up layer.

As illustrated in FIG. 2, the optical waveguide 3 included in the optical circuit board 1 according to the embodiment is positioned on the upper surface of the electrical conductor layer 21aexisting on the upper surface of the wiring board 2. FIG. 2 is an enlarged explanatory view for explaining a cross section of a region R1 illustrated in FIG. 1. One end portion of the optical waveguide 3 faces the optical component 4 including an optical transmission path 41. The other end portion of the optical waveguide 3 is connected to an optical connector 5a including an optical fiber 5.

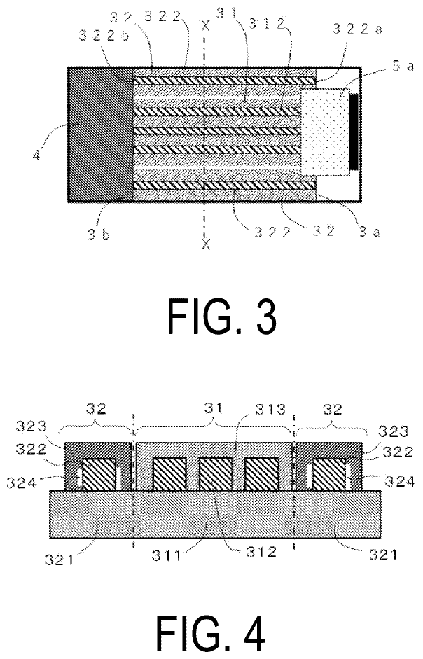

As illustrated in FIG. 3, the optical waveguide 3 includes a first optical waveguide 31 and a second optical waveguide 32. FIG. 3 is a plan view as viewed from a direction of an arrow A illustrated in FIG. 2. As illustrated in FIG. 4, the first optical waveguide 31 includes a first lower clad 311, a first core 312, and a first upper clad 313. FIG. 4 is an explanatory view for explaining a cross section taken along line X-X illustrated in FIG. 3.

The first lower clad 311 included in the first optical waveguide 31 is positioned on the upper surface of the wiring board 2, specifically, on the upper surface of the electrical conductor layer 21a existing on the upper surface of the wiring board 2. The material forming the first lower clad 311 is not limited, and examples of the material include resin such as epoxy resin or silicone resin.

The first core 312 included in the first optical waveguide 31 is positioned on the upper surface of the first lower clad 311. The first core 312 extends from an outer edge side of the wiring board 2 to a center side of the wiring board 2. In other words, in FIG. 2, the outer edge side of the wiring board 2 indicates the side (outer peripheral portion) on which the optical connector 5a is positioned, and the center side of the wiring board 2 indicates the side on which the optical component 4 is positioned. The first core 312 is a portion through which light having entered the first optical waveguide 31 propagates. That is, optical signals are transmitted and received between the first core 312 and the optical transmission path 41. Thus, one end surface of the first core 312 is positioned facing an end surface of the optical transmission path 41 included in the optical component 4 mounted on the wiring board 2.

The material forming the first core 312 is not limited and is set as appropriate in consideration of, for example, light permeability and wavelength characteristics of light propagating the first core 312. Examples of the material include resin such as epoxy resin or silicone resin. The first core 312 has a thickness of, for example, 3 μm or more and 50 μm or less.

The first upper clad 313 included in the first optical waveguide 31 is positioned covering at least part of the first core 312. Similar to the first lower clad 311, the first upper clad 313 is made of resin such as epoxy resin or silicone resin. The first lower clad 311 and the first upper clad 313 may be made of the same material or different materials. The first lower clad 311 and the first upper clad 313 may have the same thickness or different thicknesses. The first lower clad 311 and the first upper clad 313 each have a thickness of, for example, about 5 μm or more and 150 μm or less.

The second optical waveguide 32 is positioned adjacent to the first optical waveguide 31. Specifically, the second optical waveguide 32 is positioned along the first optical waveguide 31 while sandwiching the first optical waveguide 31. The second optical waveguide 32 is used for positioning for making a light beam incident in performing an optical continuity inspection of the first optical waveguide 31.

Similar to the first lower clad 311, a second lower clad 321 included in the second optical waveguide 32 is positioned on the upper surface of the wiring board 2, specifically, on the upper surface of the electrical conductor layer 21a existing on the upper surface of the wiring board 2. Similar to the first lower clad 311, the material forming the second lower clad 321 is not limited, and examples of the material include resin such as epoxy resin or silicone resin. The second lower clad 321 may be formed of the same material (resin) as or may be formed of a different material (resin) from the first lower clad 311.

As illustrated in FIG. 4, the second lower clad 321 may be integrated with the first lower clad 311 or may be separated from the first lower clad 311. For example, the second lower clad 321 and the first lower clad 311 being integrated can simplify a process in forming the first optical waveguide 31 and the second optical waveguide 32.

A second core 322 included in the second optical waveguide 32 is positioned on the upper surface of the second lower clad 321. The second core 322 is positioned along the first core 312 included in the first optical waveguide 31. Similar to the material forming the first core 312, the material forming the second core 322 is not limited, and examples of the material include resin such as epoxy resin or silicone resin. The first core 312 and the second core 322 are usually formed at the same time, and thus the material (resin) forming the first core 312 and the material (resin) forming the second core 322 may be the same. Similar to the first core 312, the second core 322 has a thickness of, for example, about 3 μm or more and 50 μm or less.

The second optical waveguide 32 includes a first end surface 3a on the outer edge side of the wiring board 2 and a second end surface 3b on the center side of the wiring board 2. That is, in FIG. 3, the end surface positioned on the optical connector 5a side is the first end surface 3a, and the end surface positioned on the optical component 4 side is the second end surface 3b. The second core 322 includes a first core end surface 322a on the outer edge side of the wiring board 2 and a second core end surface 322b on the center side of the wiring board 2. That is, the first core end surface 322a is part of the first end surface 3a, and the second core end surface 322b is a part of the second end surface 3b.

The second upper clad 323 included in the second optical waveguide 32 is positioned covering at least part of the second core 322. Similar to the second lower clad 321, the second upper clad 323 is made of resin such as epoxy resin or silicone resin. The second lower clad 321 and the second upper clad 323 may be made of the same material or different materials. The second lower clad 321 and the second upper clad 323 may have the same thickness or may have different thicknesses. The second lower clad 321 and the second upper clad 323 each have a thickness of, for example, about 5 μm or more and 150 μm or less. The second upper clad 323 is usually formed simultaneously with the first upper clad 313 included in the first optical waveguide 31. Thus, the second upper clad 323 may have the same thickness as the first upper clad 313.

As described above, the second lower clad 321 may be integrated with the first lower clad 311. On the other hand, as illustrated in FIG. 4, the second upper clad 323 may be positioned separately from the first upper clad 313. If the second upper clad 323 is positioned separately from the first upper clad 313, the first core 312 in which transmission and reception of optical signals are performed is less likely to be affected even if the second upper clad 323 is peeled off from the second core 322.

At the first end surface 3a and/or the second end surface 3b of the second optical waveguide 32, a gap 324 is between the second core 322 and the second upper clad 323, for example, as illustrated in FIG. 4. The presence of the gap 324 allows the gap 324 to be visually recognized in performing an optical continuity inspection. As a result, the position of the second core 322 can be recognized, and the position of the first core 312 on which the optical continuity inspection is performed can be easily recognized from the position of the second core 322.

The reason why the gap 324 is not formed between the first core 312 and the first upper clad 313 is that the presence of the gap 324 between the first core 312 and the first upper clad 313 increases a transmission loss. Thus, the second core 322 that does not transmit and receive optical signals is formed, and the gap 324 that can be visually recognized is formed in the vicinity of the second core 322. Based on the gap 324 that can be visually recognized, positioning for making a light beam incident on the first core 312 is performed.

The second core 322 may include a plurality of side surfaces connecting the first core end surface 322a and the second core end surface 322b. The number of the side surfaces varies depending on the cross-sectional shape of the second core 322. For example, as illustrated in FIG. 4, when the cross-sectional shape of the second core 322 is quadrilateral, there are two side surfaces. That is, in a cross-sectional view of the second core 322, surfaces other than a surface in contact with the second lower clad 321 and a surface facing the surface are the side surfaces. For example, when the cross-sectional shape of the second core 322 is hexagon, there are four side surfaces.

The gap 324 may be between at least one side surface of the plurality of side surfaces of the second core 322 and the second upper clad 323. Presence of the gap 324 between the at least one side surface and the second upper clad 323 causes the lower surface of the second core 322 to be in contact with the second lower clad 321 and causes the upper surface of the second core 322 to be in contact with the second upper clad 323. As a result, peeling off of the second core 322 from the second lower clad 321 or the second upper clad 323 can be reduced.

The plurality of side surfaces of the second core 322 may include, for example, a first side surface and a second side surface facing each other, and the gap 324 may be at both of the first side surface and the second side surface. Specifically, when the cross-sectional shape of the second core 322 is a quadrilateral, the two side surfaces face each other, one of the side surfaces is the first side surface, and the other is the second side surface. Presence of the gap 324 at both of the first side surface and the second side surface facing each other allows the position of the second core 322 to be visually recognized more accurately. As a result, the positioning for making a light beam incident can be performed more accurately. A plurality of gaps 324 may be provided at each of the first side surface and the second side surface, or a plurality of gaps 324 may be provided at only one of the first side surface and the second side surface. Further, the gap 324 may be positioned continuously between the first core end surface 322a and the second core end surface 322b or may be positioned intermittently therebetween.

A plurality of gaps 324 may be at the first end surface 3a and/or the second end surface 3b. For example, in FIG. 4, a total of two gaps 324 are such that one gap 324 exists between each of both side surfaces (the first side surface and the second side surface) of the second core 322 and the second upper clad 323. By providing the plurality of gaps 324, the visibility can be improved. As a result, the positioning for making a light beam incident can be performed more accurately. Although one gap 324 is at one side surface in FIG. 4, a plurality of gaps 324 may be at the one side surface.

The gap 324 existing between at least one side surface of the second core 322 and the second upper clad 323 may be in contact with the second lower clad 321 or may be separated from the second lower clad 321. For example, if the gap 324 is in contact with the second lower clad 321, a boundary between the second lower clad 321 and the second core 322 can be easily recognized. As a result, the positioning for making a light beam incident in the height direction of the first optical waveguide 31 can be performed more accurately.

The gap 324 may be continuous from the first end surface 3a to the second end surface 3b or may be intermittent. With the gap 324 which is continuously present, in forming the first end surface 3a and the second end surface 3b, for example, by cutting both end portions of the optical waveguide 3 at the time of forming the optical waveguide 3, the gap 324 can exist at the first end surface 3a and the second end surface 3b even when the optical waveguide 3 is cut at arbitrary portions. The gap 324 which is intermittently present is advantageous in that adhesion between the second core 322 and the second upper clad 323 can be ensured.

As described above, according to the present disclosure, the inspection efficiency of the optical waveguide 3 can be improved by the second core 322, and the optical circuit board 1 which is excellent in optical transmission can be provided.

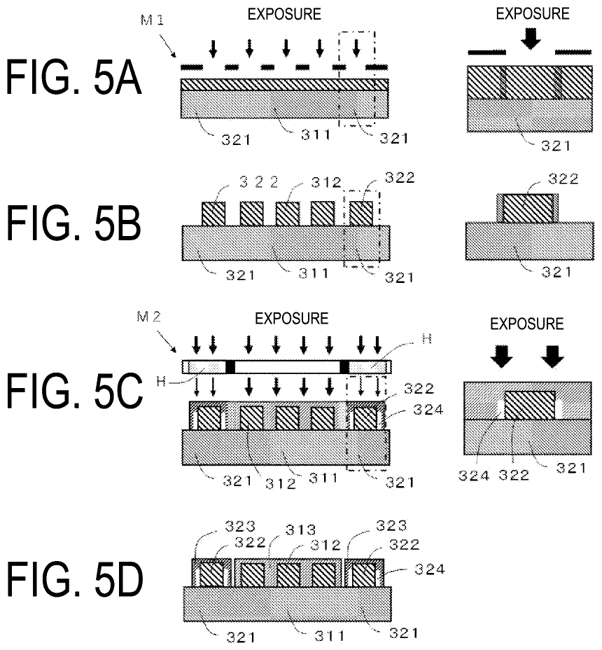

An embodiment of a method of forming the first optical waveguide 31 and the second optical waveguide 32 will be described based on FIG. 5. FIG. 5 is an explanatory view for explaining a process of forming the first optical waveguide 31 and the second optical waveguide 32 in the optical circuit board 1 according to the embodiment of the present disclosure. In FIG. 5, the drawing illustrated on the right side is an enlarged view of the region surrounded by a dash-dotted line in the drawing illustrated on the left side.

First, the first lower clad 311 and the second lower clad 321 are formed on the upper surface of the wiring board 2 (the electrical conductor layer 21a). The first lower clad 311 and the second lower clad 321 are as described above, and detailed description thereof will be omitted. The first lower clad 311 and the second lower clad 321 illustrated in FIG. 5 are integrated.

As illustrated in FIG. 5A, the material of the first core 312 and the second core 322 is disposed on the upper surfaces of the first lower clad 311 and the second lower clad 321. Examples of such a material include an uncured product of resin such as epoxy resin or silicone resin.

An exposure mask M1 is then disposed to cover the uncured product of resin. The exposure mask M1 includes openings, and the first core 312 and the second core 322 are formed at the positions of the openings. After the exposure mask M1 is disposed, exposure and development are performed to form the first core 312 on the upper surface of the first lower clad 311 and form the second core 322 on the upper surface of the second lower clad 321 as illustrated in FIG. 5B. At the time of the exposure, even portions covered with the exposure mask M1 are slightly affected by the exposure in the vicinities of the openings. Thus, insufficiently cured resin is in the vicinities of the side surfaces of the first core 312 and the second core 322.

As illustrated in FIG. 5C, the materials of the first upper clad 313 and the second upper clad 323 are then disposed to cover the first core 312 and the second core 322. Examples of such a material include an uncured product of resin such as epoxy resin or silicone resin. A half-tone mask M2 is then disposed to cover the uncured product of resin.

The half-tone mask M2 is a mask including a half-tone portion H in which the transmittance is lowered to suppress the exposure amount. The transmittance of the half-tone portion H is, for example, about 40% (specifically, about 40±10%) of the normal transmittance. A boundary portion between the first upper clad 313 and the second upper clad 323 is shielded so as not to be exposed to light. After the half-tone mask M2 is disposed, exposure and development are performed such that the first upper clad 313 is formed to cover the first core 312 and the second upper clad 323 is formed to cover the second core 322 as illustrated in FIG. 5D. Since the boundary portion between the first upper clad 313 and the second upper clad 323 is shielded so as not to be exposed to light and is not cured, the first upper clad 313 and the second upper clad 323 are positioned in a separated state.

In a portion corresponding to the second optical waveguide 32, for example, insufficiently cured resin is in the vicinities of the side surfaces of the second core 322. The portion corresponding to the second optical waveguide 32 is exposed with a light intensity smaller than the exposure amount of the first upper clad 313 when the second upper clad 323 is exposed to light. As a result, the curing reaction does not proceed particularly between the side surfaces of the second core 322 and the second upper clad 323, and the gaps 324 are likely to be formed.

A portion corresponding to the first optical waveguide 31 is exposed at a transmittance necessary for curing when the first upper clad 313 is exposed to light. Thus, the curing reaction of the insufficiently cured resin existing in the vicinities of the side surfaces of the first core 312 and the first upper clad 313 proceeds sufficiently. As a result, the first core 312 and the first upper clad 313 are sufficiently adhered to each other, and the gap 324 is not formed.

The optical component mounting structure 10 in which the optical component 4 and the electronic component 6 are mounted on the optical circuit board 1 according to an embodiment of the present disclosure will be described. As illustrated in FIG. 1, the optical component 4 mounted on the optical component mounting structure 10 according to the embodiment includes the optical transmission path 41. Examples of the optical component 4 including the optical transmission path 41 include a silicon photonics device. Examples of the electronic component 6 include an application specific integrated circuit (ASIC) and a driver IC.

As illustrated in FIG. 2, the optical component 4 is electrically connected to a pad 21b positioned in a mounting region (a region in which the optical component 4 is mounted) of the wiring board 2 via a solder 7. The pad 21b is part of the electrical conductor layer positioned on the upper surface of the wiring board 2.

As an example of the optical component 4, a silicon photonics device will be described. The silicon photonics device is, for example, a type of optical component including the optical transmission path 41 in which silicon (Si) is used as a core and silicon dioxide (SiO₂) is used as a clad. The silicon photonics device includes a Si waveguide as the optical transmission path 41, and further includes a passivation film, a light source unit, a light detector, and the like, which are not illustrated. As described above, the optical transmission path 41 (Si waveguide 41) is positioned at one end portion of the first optical waveguide 31 facing the first core 312 included in the first optical waveguide 31.

For example, an electrical signal from the wiring board 2 is propagated to the light source unit included in the optical component 4 (silicon photonics device) via the solder 7. The light source unit emits light upon receiving the propagated electrical signal. The emitted optical signal is propagated to the optical fiber 5 connected via the optical connector 5a, through the optical transmission path 41 (Si waveguide 41) and the first core 312. In the optical component mounting structure 10 according to the embodiment of the present disclosure, the optical component 4 is mounted on the optical circuit board 1 having excellent optical transmission, and thus an optical transmission loss can be reduced.

The embodiment of the present disclosure has been described above. However, the invention according to the present disclosure is not limited to the above-described embodiment, and various modifications or improvements can be made within the scope of the present disclosure described in (1) and (8) below.
(1) In the present disclosure, an optical circuit board includes a wiring board, a first optical waveguide positioned on the wiring board, and a second optical waveguide positioned adjacent to the first optical waveguide on the wiring board. The first optical waveguide includes a first lower clad positioned on the wiring board, a first core extending from an outer edge side of the wiring board to a center side of the wiring board on the first lower clad, and a first upper clad covering at least part of the first core. The second optical waveguide includes a second lower clad positioned on the wiring board, a second core positioned along the first core on the second lower clad, and a second upper clad covering at least part of the second core. The second optical waveguide includes a first end surface at which a first core end surface of the second core is exposed on the outer edge side of the wiring board and includes a second end surface at which a second core end surface of the second core is exposed on the center side of the wiring board. At the first end surface and/or the second end surface, a gap is between the second core and the second upper clad.

With regard to the embodiment of the present disclosure, the following embodiments (2) to (7) will be further disclosed.
(2) In the optical circuit board according to (1) described above, the second core includes a plurality of side surfaces connecting the first core end surface and the second core end surface, and the gap is between at least one side surface of the plurality of side surfaces of the second core and the second upper clad.
(3) In the optical circuit board according to (1) or (2) described above, the gap is continuous or intermittent from the first end surface to the second end surface.
(4) In the optical circuit board according to any one of (1) to (3) described above, one or more gaps are at the first end surface and/or the second end surface.
(5) In the optical circuit board according to any one of (1) to (4) described above, the gap is in contact with the second lower clad.
(6) In the optical circuit board according to any one of (2) to (5) described above, the plurality of side surfaces of the second core includes a first side surface and a second side surface facing each other, and the gap is at each side surface of the first side surface and the second side surface.
(7) In the optical circuit board according to any one of (1) to (6) described above, the first lower clad and the second lower clad are integrated.
(8) In the present disclosure, an optical component mounting structure includes the optical circuit board according to any one of (1) to (7) described above and an optical component mounted on the optical circuit board.

### REFERENCE SIGNS

1 Optical circuit board
2 Wiring board
21a Electrical conductor layer
21b Pad
3 Optical waveguide
31 First optical waveguide
311 First lower clad
312 First core
313 First upper clad
32 Second optical waveguide
321 Second lower clad
322 Second core
322a First core end surface
322b Second core end surface
323 Second upper clad
324 Gap
3a First end surface
3b Second end surface
4 Optical component
41 Optical transmission path (silicon waveguide (Si waveguide))
5 Optical fiber
5a Optical connector
6 Electronic component
7 Solder
10 Optical component mounting structure

1. An optical circuit board, comprising:
a wiring board;
a first optical waveguide positioned on the wiring board; and
a second optical waveguide positioned adjacent to the first optical waveguide on the wiring board,
wherein the first optical waveguide comprises
a first lower clad positioned on the wiring board,
a first core extending from an outer edge side of the wiring board to a center side of the wiring board on the first lower clad, and
a first upper clad covering at least part of the first core,
the second optical waveguide comprises
a second lower clad positioned on the wiring board,
a second core positioned along the first core on the second lower clad, and
a second upper clad covering at least part of the second core,
the second optical waveguide comprises
a first end surface at which a first core end surface of the second core is exposed on the outer edge side of the wiring board and
a second end surface at which a second core end surface of the second core is exposed on the center side of the wiring board, and
at the first end surface and/or the second end surface, a gap is between the second core and the second upper clad.

2. The optical circuit board according to claim 1,
wherein the second core comprises a plurality of side surfaces connecting the first core end surface and the second core end surface, and
the gap is between at least one side surface of the plurality of side surfaces of the second core and the second upper clad.

3. The optical circuit board according to claim 1, wherein the gap is continuous or intermittent from the first end surface to the second end surface.

4. The optical circuit board according to claim 1, wherein one or more gaps are at the first end surface and/or the second end surface.

5. The optical circuit board according to claim 1, wherein the gap is in contact with the second lower clad.

6. The optical circuit board according to claim 2,
wherein the plurality of side surfaces of the second core comprises a first side surface and a second side surface facing each other, and
the gap is at each of the first side surface and the second side surface.

7. The optical circuit board according to claim 1, wherein the first lower clad and the second lower clad are integrated.

8. An optical component mounting structure, comprising:
the optical circuit board according to claim 1; and
an optical component mounted on the optical circuit board.
